(19) United States
(12) Patent Application Publication
(10) Pub. No.: US 2010/0007560 A1
(43) Pub. Date: Jan. 14, 2010

(54) DIRECT FEEDING TYPE PATCH ANTENNA

(76) Inventors: Byung Hoon Ryou, Seoul (KR); Won Mo Sung, Gyeonggi-do (KR); Seung Up Seo, Gyeonggi-do (KR); Yun Bok Lee, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/443,966

(22) PCT Filed: Oct. 1, 2007
(86) PCT No.: PCT/KR07/04783

§ 371 Date: Sep. 23, 2009

(30) Foreign Application Priority Data
Oct. 9, 2006 (KR) 10-2006-0097849

(51) Int. Cl. H01Q 1/36

(52) U.S. Cl. 343/700 MS

(57) ABSTRACT

Disclosed herein is a direct feeding type patch antenna. The direct feeding type patch antenna according to the present invention comprises: a feed element 110 having direct feeding points 118 formed radially in opposite perpendicular directions to one another from a feeding central portion 120; four direct feeding cylindrical pillars 130 electrically connected at one ends thereof to the direct feeding points 118; and a radiation patch 140 disposed opposite to the feed element 110 and electrically connected to the other ends of the direct feeding cylindrical pillars 130, for allowing an electrical signal to be directly fed thereto. The direct feeding type patch antenna further comprises a coupler made of a ceramic material. According to the present invention, it is possible to implement a patch antenna which has a high gain and an improved axial ratio bandwidth, and is small-sized.

### TECHNICAL FIELD

The present invention relates to a direct feeding type patch antenna, and more particularly, to a patch antenna which has a high gain and an improved axial ratio bandwidth, and is small-sized.

### BACKGROUND ART

A patch antenna is an antenna manufactured by forming a micro-strip pattern on a substrate. The patch antenna is small-sized and lightweight. Also, the patch antenna enables arrangement, integration and polarization-control thereof to be easily performed.

Now, the construction of a conventional patch antenna will be described hereinafter with reference to FIGS. 1 and 2.

FIG. 1 is a perspective view showing a typical patch antenna, and FIG. 2 is a top plan view showing a patch antenna for implementing circular polarization.

As shown in FIG. 1, a linear patch antenna 20, which is widely used, is generally configured such that an aperture is formed on a ground plate 21. In the linear patch antenna 20, a feed line 22 is positioned at the center of a slot 23 and is further protruded by a length of about λ/4 from the slot 23 so as to exhibit a characteristic of generating only linear polarization.

Such a linear patch antenna 20 has a problem in that since it has a single slot, its size is inevitably increased to tune a resonant frequency.

In order to address and solve the above problem, there has been proposed a circular polarization patch antenna 30 having two slots 31 and 32 as shown in FIG. 2. The circular polarization patch antenna 30 is formed with a feed line 34 having a delay line 33 of λ/4 at one side thereof so as to implement circular polarization. Such a circular polarization patch antenna 30 is excellent in transmission characteristics and is less in multiple reflection interference, it is suitable for broadcasting and communication. However, since a circular polarization patch antenna 30 for dual feeding requires the design of a dual-delay feed line 33 and two apertures, i.e., slots 31 and 32, it entails problems in that when being mounted in a microwave circuit miniaturization of the entire circuit is not accomplished due to its complicated structure and the manufacturing cost is increased due to a decrease of productivity.

### DISCLOSURE OF INVENTION

### Technical Problem

Accordingly, an object of the present invention has been made in an effort to solve the above-mentioned problems occurring in the prior art, and it is an object of the present invention to provide a patch antenna which has a high gain and can be miniaturized.

### Technical Solution

To accomplish the above object, according to one aspect of the present invention, there is provided a direct feeding type patch antenna including: a radiation patch having direct feeding points formed radially in opposite perpendicular directions to one another from a feeding central portion; four direct feeding cylindrical pillars electrically connected at one ends thereof to the direct feeding points; and a metal patch disposed opposite to the radiation patch and electrically connected to the other ends of the direct feeding cylindrical pillars, for allowing an electrical signal to be directly fed thereto.

Preferably, the direct feeding type patch antenna further includes a coupler made of a ceramic material.

In this case, preferably, the coupler is an odd number-stage coupler.

### Advantageous Effects

As described above, according to the present invention, the direct feeding points of the radiation patch and a metal plate of the metal patch are directly connected to each other through the direct feeding cylindrical pillars so that a patch antenna can be implemented, which can be miniaturized.

In addition, according to the patch antenna of the present invention, a metal plate is used as the metal patch to reduce radiation loss due to a dielectric substance to thereby improve a gain of the antenna.

### BRIEF DESCRIPTION OF THE DRAWINGS

FIG. 1 is a perspective view showing a typical patch antenna;

FIG. 2 is a top plan view showing a patch antenna for implementing circular polarization.

FIG. 3 is an exploded perspective view showing a patch antenna according to a first embodiment of the present invention;

FIG. 4 is a side view showing an assembled state of the patch antenna of FIG. 3; and

FIG. 5 is an exploded perspective view showing a patch antenna according to a second embodiment of the present invention.

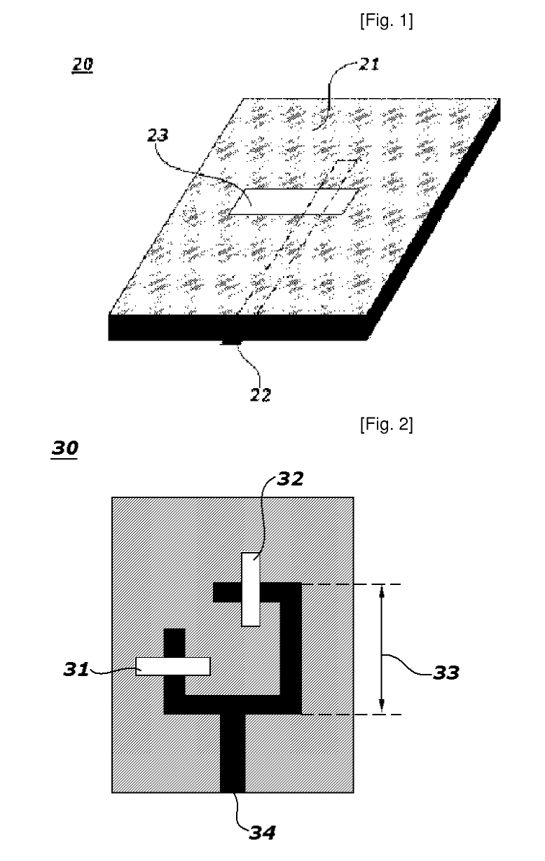

### BEST MODE FOR CARRYING OUT THE INVENTION

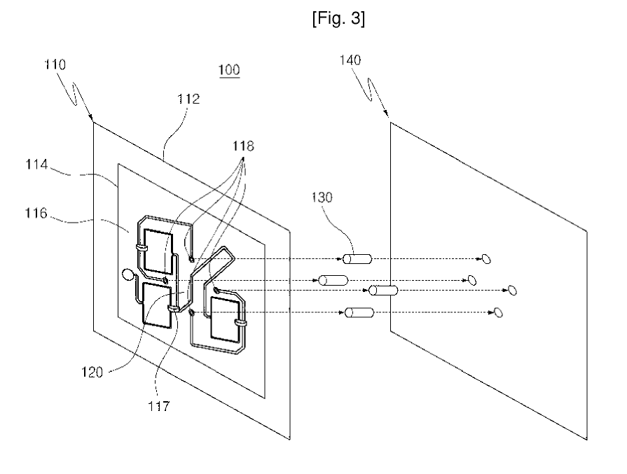

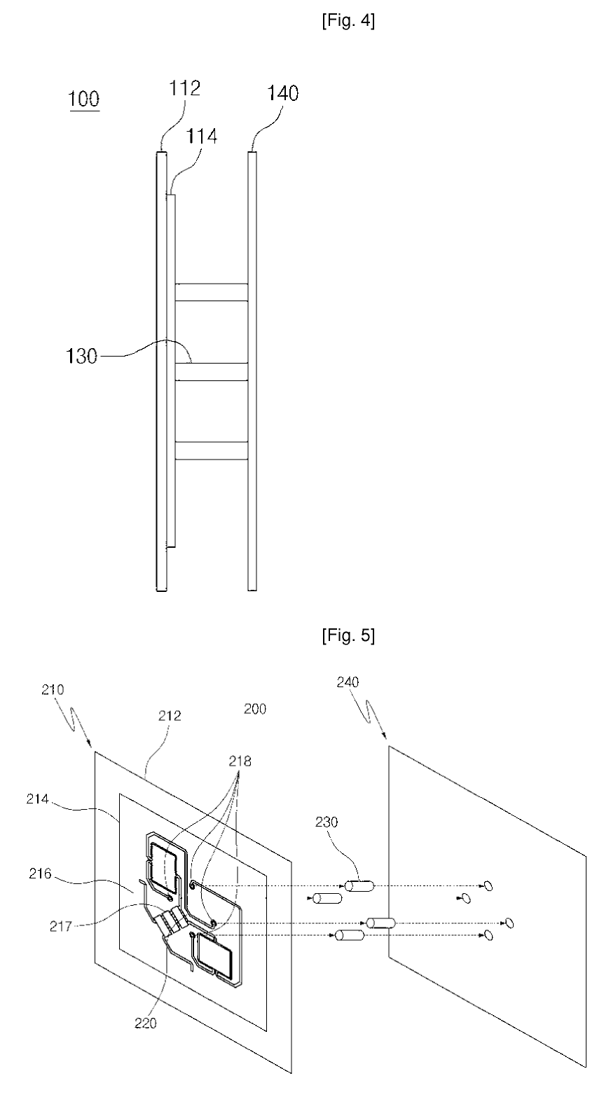

The construction of a direct feeding type patch antenna according to a first embodiment of the present invention will be described hereinafter with reference to FIGS. 3 and 4.

FIG. 3 is an exploded perspective view showing a patch antenna according to a first embodiment of the present invention, and FIG. 4 is a side view showing an assembled state of the patch antenna of FIG. 3.

As shown in FIGS. 3 and 4, a direct feeding type patch antenna (hereinafter, abbreviated as “patch antenna”) 100 according to a first embodiment of the present invention includes a feed element 110, a direct feeding cylindrical pillars 130 and a radiation patch 140.

The feeding element 110 includes a substrate 112 for receiving an external radio signal and performing a feeding operation, and a pattern section 114 disposed on one side of the substrate 112, the pattern being formed with a micro-strip pattern 116. The pattern section 114 is formed with four direct feeding points 118 using a Wilkinson divider so as to increase an axial ratio bandwidth. The direct feeding points 118 are formed at positions spaced apart by a predetermined distance radially in opposite perpendicular directions to one another from a feeding center portion 120, so that the phases between the respective feeding points 118 become 0 degree, 90 degrees, 180 degrees and 270 degrees. The direct feeding points 118 are preferably located at equivalent distances from the feeding center portion 120, but are not limited thereto. The substrate 112 and the pattern section 114 may be formed of a single module. At the direct feeding points 118, there are formed a plurality of cylindrical pillars 130 for electrically interconnecting the direct feeding points 118 and the radiation patch 140 so as to directly feed an electrical signal to the radiation patch 140.

In case of a general coupling feed, since a dielectric substrate is used as a material of which the radiation patch is made, a loss is inevitably caused by a dielectric substance, resulting in a degradation of radiation efficiency. In addition, since a conventional patch antenna performs a feeding operation using the coupling between a feeding terminal of a transmission line and a metal patch being radiated, there occurs a problem in that the height of the patch antenna is increased.

However, the direct feeding patch antenna of the present invention directly feeds to the radiation patch 140 via the cylindrical pillars 130, so that the height of the patch antenna can be reduced to thereby enable miniaturization of the patch antenna 100 and enhance radiation efficiency.

The operation of the direct feeding patch antenna of the present invention will be described hereinafter.

An electrical signal fed to the feed element is distributed by a given phase difference through a divider (not shown) via a coupler 117. The distributed signal is directly fed to the radiation patch 140 via the cylindrical pillars 130, and circular polarization is radiated to the outside due to a phase difference of the signals fed to the radiation patch 140 via the cylindrical pillars 130. In case of the patch antenna according to the present invention, four signals having a phase difference of 90 degrees are fed toward the radiation patch through the four direct feeding points 118, so that the characteristics of an axial ratio bandwidth can be improved and a power transfer effect can be further increased by using the direct feeding as compared to the coupling feeding. Moreover, a metal plate is used, rather than a dielectric substance, as an upper patch of the patch antenna so as to minimize radiation loss due to a dielectric substance to thereby improve a gain of the antenna.

When the present invention is applied to an antenna for an RFID reader, a tag recognition distance can be increased as well as the characteristics regarding directionality of the tag can be improved.

Now, the construction of a direct feeding type patch antenna according to a second embodiment of the present invention will be described hereinafter with reference to FIG. 5.

FIG. 5 is an exploded perspective view showing a patch antenna according to a second embodiment of the present invention.

As shown in FIG. 5, the patch antenna 200 according to the second embodiment features that the micro-strip coupler 117 of the patch antenna 100 according to the first embodiment is replaced with a three-stage ceramic coupler 217.

In order to implement dual-polarization using the micro-strip coupler 117, it is required that a multi-stage coupler 117 should be combined to improve isolation. However, in this case, there occurs a problem in that the physical size of the antenna is increased due to the multi-coupler 117 and a line loss according to the configuration of the coupler 117 is increased, leading to a reduction in a gain of the antenna.

As above, when the micro-strip coupler is replaced with the three-stage ceramic coupler, its physical size can be further reduced as compared to the coupler composed of a micro-strip line, and isolation of the antenna can be improved through the three-stage configuration. In addition, the patch antenna 200 according to the second embodiment can significantly reduce the line loss through the use of the ceramic coupler, thereby increasing radiation efficiency.

In the second embodiment, it has been described that the ceramic coupler 217 employs a three-stage configuration, but the spirit of the present invention is not limited thereto. Of course, it is possible to implement the patch antenna of the present invention by using the ceramic coupler 217 employing odd number-stage such as five-stage, seven-stage, etc.

While the present invention has been described with reference to the particular illustrative embodiments, it is not to be restricted by the disclosed embodiments but only by the appended claims. It is to be appreciated that those skilled in the art can change or modify the embodiments without departing from the scope and spirit of the present invention.

1. A direct feeding type patch antenna comprising: a feed element having direct feeding points formed radially in opposite perpendicular directions to one another from a feeding central portion; four direct feeding cylindrical pillars electrically connected at one ends thereof to the direct feeding points; and
a radiation patch disposed opposite to the feed element and electrically connected to the other ends of the direct feeding cylindrical pillars, for allowing an electrical signal to be directly fed thereto.

2. A direct feeding type patch antenna comprising:
a coupler made of a ceramic material and electrically connected at one end thereof to a feed section so as to improve isolation of a signal fed thereto from the feed section;
a feed element electrically connected to the other end of the coupler, the feed element having direct feeding points formed radially in opposite perpendicular directions to one another from a feeding center portion; four direct feeding cylindrical pillars electrically connected at one ends thereof to the direct feeding points; and
a radiation patch disposed opposite to the feed element and electrically connected to the other ends of the direct feeding cylindrical pillars, for allowing an electrical signal to be directly fed thereto.

3. The direct feeding type patch antenna according to claim 2, wherein the coupler is an odd number-stage coupler.

4. The direct feeding type patch antenna according to claim 1, wherein the feed element comprises a substrate and a pattern section disposed on one surface of the substrate, the pattern section being formed with a micro-strip pattern.

5. The direct feeding type patch antenna according to claim 1, wherein the antenna is applicable to an RFID antenna.
